(19) United States
(12) Patent Application Publication
(10) Pub. No.: US 2010/0201937 A1
(43) Pub. Date: Aug. 12, 2010

(54) QUICK-CONNECT ATTACHMENT FOR EYEGLASS TEMPLE PIECE

(75) Inventor: Francois Gardaz, Nice (FR)

Correspondence Address: YOUNG & THOMPSON, 209 Madison Street, Suite 500, Alexandria, VA, 22314, US

(73) Assignee: PLUSOPTIC LTD, MACAO (CN)

(21) Appl. No.: 12/595,453

(22) PCT Filed: Apr. 12, 2007
(86) PCT No.: PCT/FR2007/051104

§ 371 Date: Oct. 9, 2009

(51) Int. Cl. G02C 5/14

(52) U.S. Cl. 351/116

(57) ABSTRACT

A quick connection for an eyeglass temple piece (1), having a first element provided with a flexible leaf (2) configured to interact with an aperture (13) positioned on a second element, characterised in that it includes elements of guidance and limitation of deformation of the flexible leaf (2). The quick connection is applicable to all types of eyeglasses, sunglasses or goggles.

The present invention relates to a quick-connect attachment for eyeglass temple pieces.

It will be used for all types of eyeglasses, sunglasses or even goggles.

Removal eyeglass temple pieces are known from the state of the art and are described in documents U.S. Pat. No. 5,007,728 or U.S. Pat. No. 6,834,952.

These two documents describe eyeglass temple pieces which are attached to a frame by a clip system comprising an element having an elasticity capable of being deformed to interact with an aperture.

The devices described in these documents suffer from certain drawbacks.

In fact, the elastic element serving as the clip is not robust, and the user can accidentally or intentionally pull the elastic element upwards or laterally beyond its elastic or breaking limit. The elastic element is then damaged and can no longer be used.

Consequently, a need exists for providing removable eyeglass temple pieces with quick, robust connection.

For this purpose the invention relates to a quick connection for an eyeglass temple piece comprising a first element provided with a flexible leaf configured to interact with an aperture positioned on a second element, characterised in that it comprises means of guiding and limiting the deformation of the flexible leaf.

The means of guidance: the flexible leaf is guided in its deformation in a precise, specific direction. Its movement is more precise and clearly delimited, preferably laterally.

The means of guidance advantageously consist of a channel transversal to the first element and configured to receive a rod connected to the flexible leaf so that it laterally guides the vertical deformation of the flexible leaf.

It will be noted that the rod and the channel may have all kinds of cylindrical, rectangular or other cross-sections, but are nevertheless capable of interacting.

The connection according to the invention is robust and allows less precise and more frequent use than the devices described in the state of the art.

The means of limitation: these are designed to limit the course of the flexible leaf by means of stops in the sinked and open positions, which contributes to improving the solidity of the flexible leaf.

In fact, the flexible leaf according to the invention cannot be damaged by excessive opening or sinking.

According to the variants of the invention the quick connection is such that:
the first element is a temple piece reinforcement capable of connecting a second element to the rest of an eyeglass frame, and the second element is an eyeglass temple piece.
the means of guidance consist of a channel transverse to the first element and is configured to receive a rod connected to the flexible leaf in order to guide the flexural deformation of the flexible leaf laterally.
the rod is provided at its free end with a bulge configured to limit the course of the rod across the channel in the open position.
the bulge is produced by punching—shearing
the angle formed between the rod and the flexible leaf is configured to abut against the external inlet of the channel in order to limit the course of the flexible leaf in the sinked position.
The flexible leaf and the rod comprise a single block unit.
the flexible leaf has an inner face that is configured to limit the space between the flexible leaf and the first element.
the first element is configured to limit the space with the flexible leaf
the flexible leaf is welded to the first element
the first element is manufactured by stamping.

The invention also relates to an eyeglass frame comprising at least one quick connection for an eyeglass temple piece, as previously described.

The attached drawings are provided by way of example and do not limit the scope of the invention. They represent only one embodiment of the invention and will enable it to be easily understood.

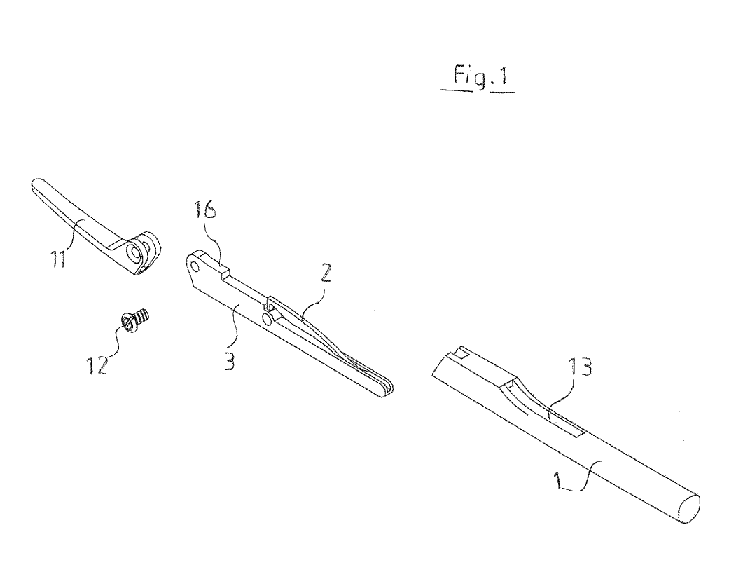

FIG. 1: view of the elements comprising the quick connection and eyeglass frame according to the invention.

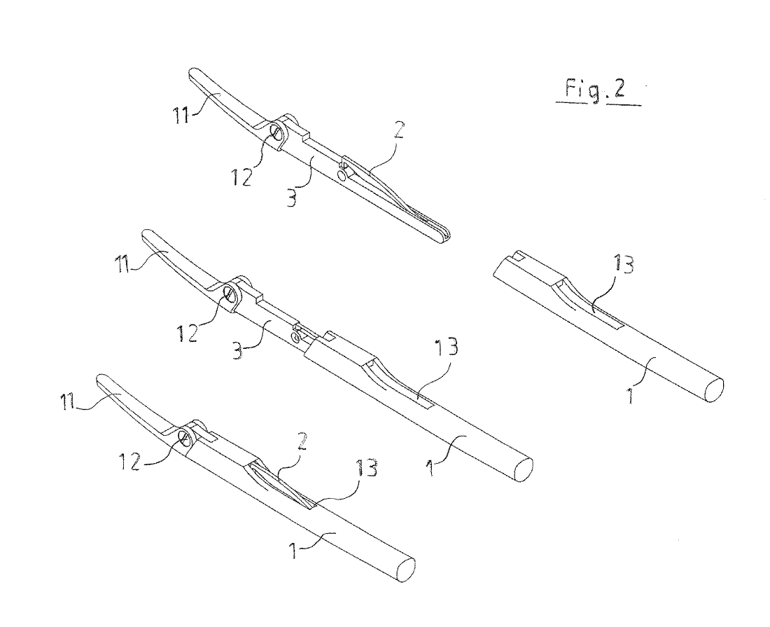

FIG. 2: successive stages of the operation of the quick connection according to the invention.

FIG. 3: sectional view of the quick connection according to the invention.

FIG. 4: detailed view of the means of guidance and limitation of the flexible leaf in the open position.

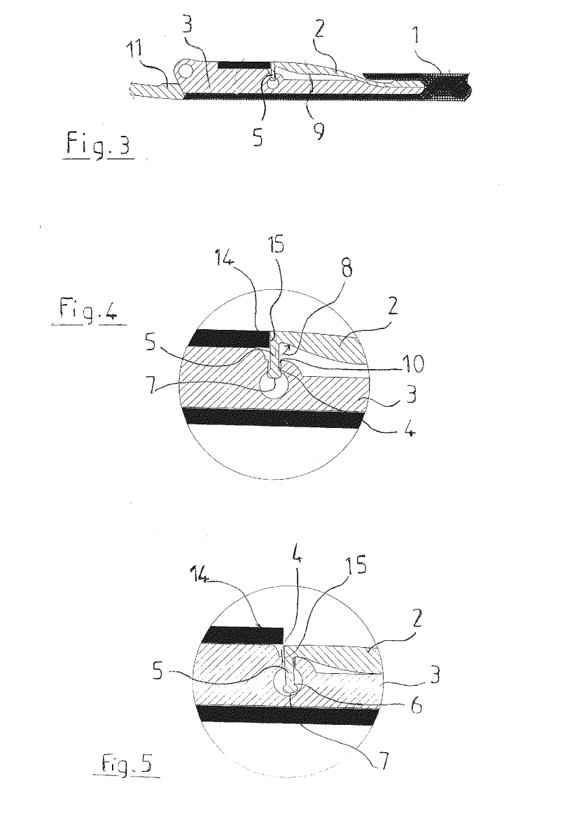

FIG. 5: detailed view of the means of guidance and limitation of the flexible leaf in the sinked position.

The quick connection according to the invention comprises a first element provided with a flexible leaf 2 configured to interact with an aperture 13 positioned on a second element. Characteristically, it comprises means of guidance and limitation of deformation of flexible leaf 2.

According to a preferred embodiment of the invention, the first element is a temple piece reinforcement 3 capable of connecting a second element to a socket 11 of an eyeglass frame and the second element is an eyeglass temple piece 1.

This arrangement appears to be most cost-effective to the user because temple piece reinforcement 3 is manufactured and sold simultaneously with the eyeglass frame and the user only re-purchases new eyeglass temple pieces 1 according to his requirements.

However, it is possible to provide the reverse arrangement, i.e. where flexible leaf 2 is located on a level with eyeglass temple piece 1 and aperture 13 on a part suitable for connecting eyeglass temple piece 1 to socket 11 of the eyeglass frame.

The means of guidance and limitation of deformation according to the invention are advantageous because they limit the lateral or vertical accidental or intentional deformations that may damage flexible leaf 2.

The means of guidance comprise a channel 4 transversal to temple piece reinforcement 3 and are configured to receive a rod 5 connected to flexible leaf 2 so as to guide the vertical deformation of flexible leaf 2 laterally.

Channel 4 may have a rectangular, cylindrical or other cross-section, as may rod 5.

However, rod 5 may be able to slide in channel 4.

Rod 5 is advantageously and essentially positioned perpendicularly to the longitudinal axis of flexible leaf 2.

In a preferential manner, to increase the solidity of the quick connection according to the invention, rod 5 and flexible leaf 2 consist of a single block part. Therefore flexible leaf 2 is manufactured directly with rod 5.

However, consideration may be given to fasten rod 5 to flexible leaf 2 by welding or by another method.

Rod 5 is advantageously provided at its free end 6 with a bulge 7 configured to limit the course of rod 5 along channel 4 in the open position.

Therefore, bulge 7 abuts against the internal inlet of channel 4, limiting the exit of rod 5 outside channel 4, and hence the vertical deformation towards the top of flexible leaf 2.

Flexible leaf 2 cannot be excessively pulled towards the outside beyond its elastic breaking limit.

The deformation movement in the sinked position of flexible leaf 2 is also controlled by a sinking stop, consisting of angle 8 formed between rod 5 and flexible leaf 2.

When flexible leaf 2 is subject to pressure when sinking, angle 8 abuts against external inlet 10 of channel 4.

Therefore flexible leaf 2 cannot be excessively pushed when sinking.

According to a possibility represented in FIGS. 1 to 5, the inner end of channel 4 opens onto an essentially circular cavity. The purpose of this cavity is to facilitate the manufacture of the quick connection according to the invention, in particular of bulge 7.

Therefore rod 5 is inserted in channel 4 since its free end 6 is not yet provided with bulge 7. Punching—shearing tools are then inserted in the essentially cylindrical cavity to allow the formation of bulge 7.

According to one possibility, the punching—shearing tool consists of two punches. The first is a half-cylinder. The second is cylindrical and comprises two stepped semi-circles, one shearing and the other crushing free end 6 of rod 5 to form bulge 7. This tool is advantageous because it enables the length of rod 5 to be precisely controlled so that it is not damaged when flexible leaf 2 is sinked.

Other arrangements for producing bulge 7 may be considered.

Flexible leaf 2 is preferably welded to temple piece reinforcement 3. To conceal this weld a longitudinal groove may be provided in reinforcement 3, enabling the welding to be carried out at the bottom of the groove without being unattractive.

To limit the costs and production times, temple piece reinforcement 3 is formed by stamping from a flat sheet.

Provision may be made for this quick connection according to the invention to be positioned more to the rear of the eyeglass temple piece, for example level with the temple piece located close to the eyes of the user. This arrangement may enable a hearing aid for the hard of hearing or audio headphones or other element to be fitted.

The quick connection according to the invention may be manufactured either in a plastic or metal material, or by a combination of both.

For example, temple piece reinforcement 3 may be manufactured in metal by the stamping method, and temple piece reinforcement 1 may be manufactured in plastic to allow different and varied colours, shapes and motifs.

From the aesthetic point of view it is preferable for aperture 13 of the quick connection for eyeglass temple pieces to be located on the inner face, opposite the head of the user, so that it is no longer visible once the eyeglass is worn by the user.

The quick connection according to the invention may be fixed directly to a socket 11 of a metal or plastic or other eyeglass frame or directly to lenses.

The quick connection is advantageously attached to socket 11 of the eyeglass frame by means of a hinge screw 12 interacting with socket 11 and temple piece reinforcement 3. Socket 11 may be connected either to a recess or directly to the glasses of an eyeglass frame.

Flexible leaf 2 has, advantageously, an inner face 9 configured to limit the space between flexible leaf 2 and temple piece reinforcement 3, which limits the possibility of hair or other small objects becoming caught between flexible leaf 2 and temple piece reinforcement 3, causing jamming of the quick connection.

According to another possibility, the longitudinal groove in which flexible leaf 2 is welded may run throughout the length of temple piece reinforcement 3 and may be relatively deep, with relatively high walls to aid limiting the space between flexible leaf 2 and temple piece reinforcement 3. This space may even be zero.

Flexible leaf 2 is a spring leaf. Flexible leaf 2 has an open position, when it is open and is not subject to any pressure. The opening of flexible leaf 2 is limited in opening by bulge 7 abutting against the internal inlet of channel 4. When a sinking pressure is generated, flexible leaf 2 adopts a sinked position, and immediately the sinking pressure ceases, flexible leaf 2 returns to its open position.

### Mode of Operation of the Quick Connection According to the Invention:

When the user wishes to adapt an eyeglass temple piece 1 to his eyeglass frame, he inserts and slides an eyeglass temple piece 1 onto temple piece reinforcement 3 connected to a socket 11 of the eyeglass frame by a hinge screw 12 so that aperture 13 and flexible leaf 2 lie on the same side.

Temple piece reinforcement 3 serves as a slide to allow the guidance of hollow eyeglass temple piece 1 to allow its interaction with temple piece reinforcement 3. In fact, flexible leaf 2 advantageously has an upper face designed to favour the sliding of eyeglass temple piece 1 on temple piece reinforcement 3. Therefore it is preferable for it to have a sloping shape.

Flexible leaf 2 is then sinked because of the pressure created by eyeglass temple piece 1 and is then in the sinked position. However, flexible leaf 2 is not sufficiently sinked to engage the sinking stop.

When eyeglass temple piece 1 is fully inserted, flexible leaf 2 undergoes an opening deformation, resuming an open position, and is positioned in aperture 13.

Eyeglass temple piece 1 is then locked onto temple piece reinforcement 3 by the quick connection. The quick connection is configured to ensure that flexible leaf 2, in the open position, interacts with a face 15 with periphery 14 of aperture 13, blocking the return of eyeglass temple piece 1 from temple piece reinforcement 3. Similarly, the quick connection is configured so that the insertion stroke of eyeglass temple piece 1 on temple piece reinforcement 3 is advantageously limited by a stop 16 of temple piece reinforcement 3.

Flexible leaf 2 is limited in its opening course by bulge 7 abutting against the inner face of channel 4, and not by aperture 13.

Aperture 13 is advantageously of an essentially longitudinal shape so that it interacts with flexible leaf 2, which is essentially of a longitudinal shape.

When the user removes eyeglass temple piece 1 from temple piece reinforcement 3 he generates a sinking pressure on flexible leaf 2, located in aperture 13, and also generates a return translation movement of eyeglass temple piece 1 relative to the rest of the eyeglass frame.

The different stages mentioned above are then made in the other direction.

The quick connection according to the invention is advantageous in that it enables the user to change the material, shape, texture, colour or motif of his eyeglass temple pieces as required.

### REFERENCES

1. Eyeglass temple piece

2. Flexible leaf

3. Temple piece reinforcement

4. Channel

5. Rod

6. Free end

7. Bulge

8. Angle

9. Inner face

10. External inlet of the channel

11. Socket

12. Hinge screw

13. Aperture

14. Periphery of the aperture

15. Face

16. Stop

1. A quick connection for an eyeglass temple piece (1) comprising a first element provided with a flexible leaf (2) configured for interacting with an aperture (13) positioned on a second element, characterised in that it comprises means of guidance and limitation of deformation of the flexible leaf (2).

2. The connection according to claim 1, wherein the first element is a temple piece reinforcement (3) capable of connecting a second element to the rest of an eyeglass frame and the second element is an eyeglass temple piece (1).

3. The connection according to claim 1, wherein the guidance means comprise a channel (4) transversal to the first element configured to receive a rod (5) connected to the flexible leaf (2) so as to guide the flexural deformation of the flexible leaf (2) laterally.

4. The connection according to claim 3, wherein the rod (5) is provided at its free end (6) with a bulge (7) configured to limit the course of the rod (5) along the channel (4) in the open position.

5. The connection according to claim 4, wherein the bulge (7) is produced by punching—shearing.

6. The connection according to claim 3, wherein the angle (8) formed between the rod (5) and the flexible leaf (2) is configured to abut against the external inlet (10) of the channel (4) so as to limit the course of the flexible leaf (2) in the sinked position.

7. The connection according to claim 3, wherein the flexible leaf (2) and the rod (5) consist of a single-block part.

8. The connection according to claim 1, wherein the flexible leaf (2) has an inner face (9) configured to limit the space between the flexible leaf (2) and the first element.

9. The connection according to claim 1, wherein the first element is configured to limit the space with the flexible leaf (2).

10. The connection according to claim 1, wherein the flexible leaf (2) is welded to the first element.

11. The connection according to claim 1, wherein the first element is manufactured by stamping.

12. An eyeglass frame comprising at least one quick connection for an eyeglass temple piece, as claimed in claim 1.

13. The connection according to claim 2, wherein the guidance means comprise a channel (4) transversal to the first element configured to receive a rod (5) connected to the flexible leaf (2) so as to guide the flexural deformation of the flexible leaf (2) laterally.

14. The connection according to claim 4, wherein the angle (8) formed between the rod (5) and the flexible leaf (2) is configured to abut against the external inlet (10) of the channel (4) so as to limit the course of the flexible leaf (2) in the sinked position.

15. The connection according to claim 5, wherein the angle (8) formed between the rod (5) and the flexible leaf (2) is configured to abut against the external inlet (10) of the channel (4) so as to limit the course of the flexible leaf (2) in the sinked position.

16. The connection according to claim 4, wherein the flexible leaf (2) and the rod (5) consist of a single-block part.

17. The connection according to claim 5, wherein the flexible leaf (2) and the rod (5) consist of a single-block part.

18. The connection according to claim 6, wherein the flexible leaf (2) and the rod (5) consist of a single-block part.
